(19) United States
(12) Patent Application Publication
(10) Pub. No.: US 2004/0145099 A1
(43) Pub. Date: Jul. 29, 2004

(54) Mono-tube type hydraulic shock absorber

(76) Inventor: Shigeru Kojima, Tokyo (JP)

Correspondence Address: RABIN & Berdo, PC, 1101 14TH STREET, NW, SUITE 500, WASHINGTON, DC, 20005, US

(21) Appl. No.: 10/755,441

(22) Filed: Jan. 13, 2004

(30) Foreign Application Priority Data
Jan. 28, 2003 (JP) 2003-18287

(51) Int. Cl. F16F 9/14

(52) U.S. Cl. 267/64.15; 267/217; 188/297

(57) ABSTRACT

This invention provides a mono-tube type shock absorber comprising: a cylinder having one closed end, a free piston sliding portion, a piston sliding portion, and a bearing portion provided in an end portion of the cylinder and having a pass through portion; a free piston slidably provided within of free piston sliding portion of the cylinder, the free piston dividing an inside of the cylinder into a gas chamber and an oil chamber; a piston slidably provided within of free piston sliding portion of the cylinder, the piston dividing the oil chamber into two oil chambers; a rod having one end fixed to the piston, the rod being provided to pass through the bearing portion so as to be capable of projection and retraction with respect to the cylinder; and a sealing portion provided in a through portion of the bearing portion, wherein an inner diameter of the free piston sliding portion of the cylinder, in which the free piston slides, is set larger than an inner diameter of the piston sliding portion of the cylinder, in which the piston slides.

### FIELD OF THE INVENTION

This invention relates to a mono-tube type hydraulic shock absorber that is used in a suspension apparatus of a vehicle such as an automobile.

### BACKGROUND OF THE INVENTION

One example of a mono-tube type hydraulic shock absorber is a technique disclosed in Japanese Utility Model Application Laid-open No. Sho 58-69136.

Referring to FIG. 2, an action of the prior art mono-tube type hydraulic shock absorber is explained. During an extension stroke of a rod 13, a working fluid within a pressurized rod chamber 11 pushes open an extension side valve 9, through an extension side port 8, and flows to an opposing rod chamber 12 side at the same time as it generates an extension side damping force. Further, during a compression stroke of the rod 13, the working fluid within the pressurized opposing rod chamber 12 pushes open a compression side valve 7 through a compression side port 6, and flows to the rod chamber 11 side at the same time as it generates a compression side damping force.

However, in the conventional mono-tube type hydraulic shock absorber, the oil temperature within an oil chamber O increases due to the rod 13 repeatedly sliding, and this causes volumetric expansion to occur. At the same time, the temperature also increases in a gas chamber G adjacent to the oil chamber O through a free piston 2, and the pressure within the gas chamber G increases.

The increase in pressure within the gas chamber G causes volumetric expansion of the gas chamber G, and causes the free piston 2 to travel to the oil chamber O side. This volumetric expansion, together with the volumetric expansion of the working fluid itself, causes an increase in the pressure applied to an oil seal 4 through a gap between a bearing 3 and the rod 13 and through an oil return hole 10 formed in the bearing 3.

Essentially, in the mono-tube type hydraulic shock absorber, pressure is applied directly through the gap between the bearing 3 and the rod 13 and through the oil return hole 10. An oil seal having high reliability at high pressure is therefore employed as the oil seal 4. However, when the pressure load is applied frequently to the oil seal 4, this may lead to such a problem that the lifetime of the oil seal 4 itself will become shorter.

It is therefore an object of this invention to provide a mono-tube type hydraulic shock absorber having a structure that increases the lifetime of an oil seal.

### SUMMARY OF THE INVENTION

In order to achieve above object, this invention provides a mono-tube type shock absorber comprising: a cylinder having one closed end, a free piston sliding portion, a piston sliding portion, and a bearing portion provided in an end portion of the cylinder and having a pass through portion; a free piston slidably provided within of free piston sliding portion of the cylinder, the free piston dividing an inside of the cylinder into a gas chamber and an oil chamber; a piston slidably provided within of free piston sliding portion of the cylinder, the piston dividing the oil chamber into two oil chambers; a rod having one end fixed to the piston, the rod being provided to pass through the bearing portion so as to be capable of projection and retraction with respect to the cylinder; and a sealing portion provided in a through portion of the bearing portion, wherein an inner diameter of the free piston sliding portion of the cylinder, in which the free piston slides, is set larger than an inner diameter of the piston sliding portion of the cylinder, in which the piston slides.

### BRIEF DESCRIPTION OF THE DRAWINGS

FIG. 1 is a cross sectional view of a mono-tube type hydraulic shock absorber, which shows a first embodiment of this invention.

FIG. 2 is a cross sectional view that shows a conventional mono-tube type hydraulic shock absorber.

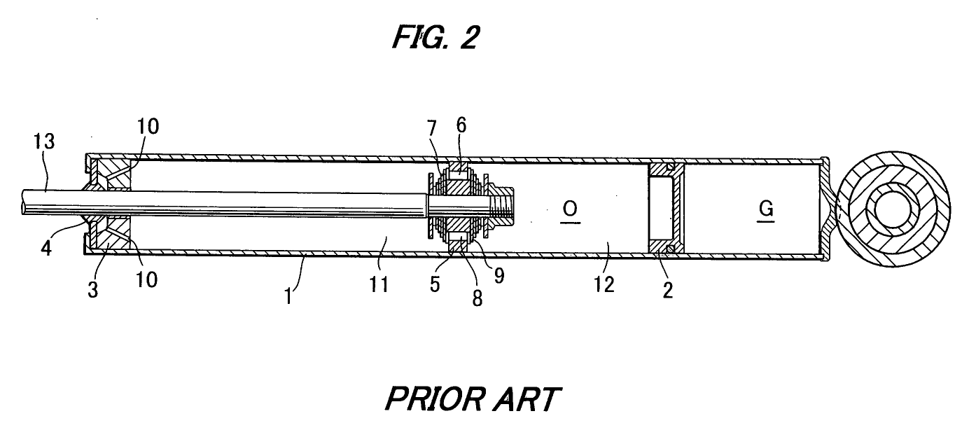

### DETAILED DESCRIPTION OF THE PREFERRED EMBODIMENTS

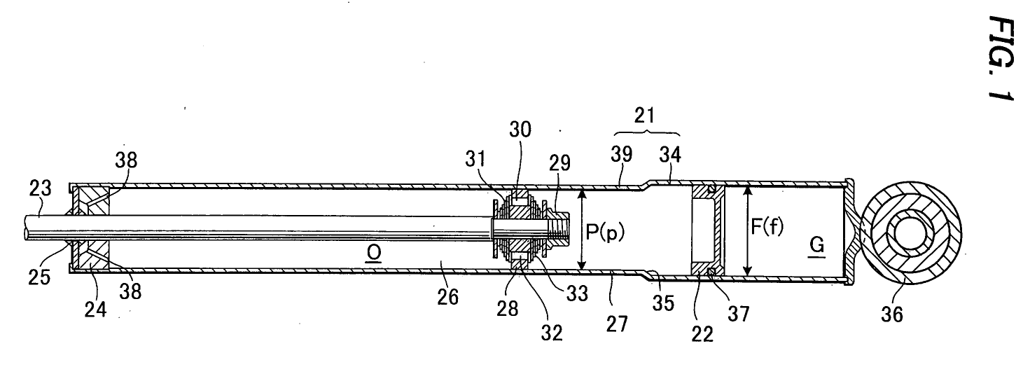

Based on FIG. 1, an embodiment of this invention in which the invention is embodied in a mono-tube type hydraulic shock absorber used in a suspension apparatus of an automobile is explained below.

The mono-tube type hydraulic shock absorber is provided with a cylinder 21 having one closed end, a free piston 22 which is slidably provided within the cylinder 21 and divides an inside of the cylinder 21 into a high pressure gas chamber G and an oil chamber O, and a piston 28 which is also slidably provided within the cylinder 21 and divides an inside of the oil chamber O into a rod side chamber 26 and an opposing side chamber 27. A rod 23 is coupled to the piston 28. One end of the rod 23 passes through a bearing 24 that is disposed in the open end of the cylinder 21, thus protruding to the outside. In addition, the bearing 24 that slidably supports the rod 21, and an oil seal 25 that prevents a working fluid, which may leak out from a gap between the rod 23 and the bearing 24, from leaking out to the outside, are provided on the open end side of the cylinder 21.

An inner portion of the cylinder 21 is divided into a piston sliding portion 39, in which the piston 28 slides, and a free piston sliding portion 34, in which the free piston 22 slides. A step portion 35 is formed at a boundary between the piston sliding portion 39 and the free piston sliding portion 34, regulating an inner diameter difference between each of the sliding portions.

Further, the piston 28 is fastened secularly to the rod 23 in an axial direction by a nut 29.

A compression side port 30 and an extension side port 32 that link the rod chamber 26 and the opposing rod chamber 27 with each other are formed in the piston 28. In addition, a compression side valve 31 that opens and closes the compression side port 30 is provided on the rod chamber 26 side, and further, an extension valve 33 that opens and closes the extension side port 32 is provided on the opposing rod chamber 27 side. The compression valve 31 and the extension valve 33 are both fastened to a tip of the rod 23 together with the piston 28 with the nut 29.

Characteristic structures of this invention are explained next.

An inner diameter of the free piston sliding portion 34 of the cylinder 21, in which the free piston 22 slides, is taken as D1. Further, an inner diameter of the piston sliding portion 39 of the cylinder 21, in which the piston 28 slides, is taken as D2. With this invention, the inner diameter D1 of the free piston sliding portion 34 is set larger than the inner diameter D2 of the piston sliding portion 39.

Furthermore, a collar 36 is fixed to a closed end portion of the cylinder 21. A rubber bushing is press fit into the collar 36. It should be noted that reference numeral 37 in FIG. 1 denotes an O-ring that is attached to the free piston 22, and that reference numeral 38 denotes an oil return hole that is formed in the bearing 24.

In the mono-tube type hydraulic shock absorber of this invention, the working fluid within the pressurized rod chamber 26 pushes open the extension side valve 33, through the extension side port 32, during an extension stroke of the rod 23 and flows to the opposing rod chamber 27 side at the same time as it generates an extension side damping force. Further, the working fluid within the pressurized opposing rod chamber 27 pushes open the compression side valve 31, through the compression side port 30, during a compression stroke of the rod 23, and flows to the rod chamber 26 at the same time as it generates a compression side damping force.

The oil temperature within the rod chamber 26 and the oil temperature within the opposing rod chamber 27 raise while the extension and compression strokes of the rod 23 are repeated, particularly under a high temperature environment. And the volumetric expansion within the rod chamber 26 and the opposing rod chamber 27 thus develops. An increase in pressure due to the volumetric expansion increases the pressure within the gas chamber G which is adjacent to the opposing rod chamber 27 through the free piston 22. This increase in internal pressure acts on the oil seal 25, increasing the pressure acting on the oil seal 25.

In this invention, however, the inner diameter D1 of the free piston sliding portion 34 in which the free piston 22 slides is set larger than the inner diameter D2 of the piston sliding portion 39 in which the piston 28 slides. Consequently, the capacity of the gas chamber G can be set larger. An increase in pressure is accordingly less liable to occur and thus an increase in the internal pressure of the gas chamber G can be suppressed.

Therefore, the pressure load on the oil seal 25, which is caused by internal pressure increase of the gas chamber G, can be reduced, and the lifetime of the oil seal itself can be extended.

In particular, the high pressure gas chamber G possesses a quality whereby the internal pressure increases quadraticly with respect to temperature. Restraining the increase in internal pressure, which is caused by the temperature increase, by using the structure described above is therefore effective in keeping the pressure load applied to the oil seal 25 from increasing.

Furthermore, in this embodiment, the step portion 35, which regulates the movement of the free piston 22, is provided in the inner diameter portion of the boundary portion between the free piston sliding portion 34 and the piston sliding portion 39. The distance that the free piston 22 can move due to the gas pressure within the gas chamber G is consequently regulated by the length of the free piston sliding portion 34.

Therefore, even if an oil leak occurs from the oil seal 25 that has deteriorated due to an excessively large pressure load, for example, the free piston 22 does not travel to the open end side of the cylinder 21 beyond the length of the free piston sliding portion 34. The amount of the oil leak based on the gas pressure of the gas chamber G from the oil seal 25 can suppress.

It should be noted that, although the embodiment discussed above is directed to an example in which the oil seal 25 is disposed on the open end side of the cylinder 21 from the cylinder 24, this invention is not limited to this embodiment. For example, the oil seal 24 may also be disposed on the rod chamber 26 side from the bearing 24.

In this invention, the inner diameter D1 of the free piston sliding portion 34 of the cylinder 21 in which the free piston 22 slides is therefore set larger than the inner diameter D2 of the piston sliding portion 39 of the cylinder 21 in which the piston 28 slides. Consequently, the capacity of the gas chamber G can be made larger. Thus, the internal pressure is less liable to increase due to increases in temperature, such as oil temperature, and volumetric expansion of the gas chamber G can be suppressed. Therefore, the pressure load on the oil seal 25, which is caused by internal pressure expansion of the gas chamber G, can be reduced, and the lifetime of the oil seal itself can be extended. Furthermore, the length of the cylinder 21 in the axial direction needs not to be extended even though the capacity of the gas chamber G is increased, and thus the basic length of the shock absorber does not become larger.

Furthermore, the step portion 35, which regulates the amount of sliding of the free piston 22, is provided in the inner diameter portion of the boundary portion between the free piston sliding portion 34 and the piston sliding portion 39. The distance that the free piston 22 can slide due to the gas pressure within the gas chamber G is consequently regulated by the length of the free piston sliding portion 34. Therefore, even if an oil leak occurs from an oil seal portion that has deteriorated due to the pressure load, for example, the free piston 22 does not travel to the open end side of the cylinder 21 beyond the length of the free piston sliding portion 34. The amount of the oil leak based on the gas pressure of the gas chamber G from the oil seal 25 can suppress.

What is claimed is:

1. A mono-tube type hydraulic shock absorber comprising:
a cylinder having one closed end, a free piston sliding portion, a piston sliding portion, and a bearing portion provided in an end portion of the cylinder and having a pass through portion;
a free piston slidably provided within of free piston sliding portion of the cylinder, the free piston dividing an inside of the cylinder into a gas chamber and an oil chamber;
a piston slidably provided within of free piston sliding portion of the cylinder, the piston dividing the oil chamber into two oil chambers;
a rod having one end fixed to the piston, the rod being provided to pass through the bearing portion so as to be capable of projection and retraction with respect to the cylinder; and
a sealing portion provided in a through portion of the bearing portion,
wherein an inner diameter of the free piston sliding portion of the cylinder, in which the free piston slides, is set larger than an inner diameter of the piston sliding portion of the cylinder, in which the piston slides.

2. The mono-tube type hydraulic shock absorber according to claim 1, wherein a step portion that regulates an amount of slide of the free piston is provided at a boundary between the free piston sliding portion and the piston sliding portion.
